(19) United States
(12) Patent Application Publication
(10) Pub. No.: US 2013/0115137 A1
(43) Pub. Date: May 9, 2013

(54) SENSING MATERIALS FOR SELECTIVE AND SENSITIVE DETECTION OF HYDROCARBONS AND ACIDS

(71) Applicants: Nongjian Tao, Scottsdale, AZ (US); Erica Forzani, Mesa, AZ (US)

(72) Inventors: Nongjian Tao, Scottsdale, AZ (US); Erica Forzani, Mesa, AZ (US)

(73) Assignee: THE ARIZONA BOARD OF REGENTS FOR AND ON BEHLAF OF ARIZONA STATE UNIVERSITY, Scottsdale, AZ (US)

(21) Appl. No.: 13/695,883

(22) PCT Filed: May 4, 2011
(86) PCT No.: PCT/US11/35220

§ 371 Date: Jan. 11, 2013

Related U.S. Application Data
(60) Provisional application No. 61/331,723, filed on May 5, 2010.

(51) Int. Cl. G01N 5/02

(52) U.S. Cl. CPC G01N 5/02
USPC 422/88

(57) ABSTRACT

A method and apparatus including: 1) Synthesis of a sensing material with high density of binding sites and excellent selectivity for toxic hydrocarbons and acid vapors; 2) Coating of the sensing material onto the surface of sensors, such as quartz crystal tuning forks; and 3) integration of the coated sensors with proper sample conditioning unit. The device achieves high sensitivity and selectivity, and has been tested in various field environments.

### CROSS-REFERENCE TO RELATED APPLICATIONS

This application claims the benefit of the priority date of U.S. Provisional Patent Application Ser. No. 61/331,723 filed on May 5, 2010, and entitled “SENSING MATERIALS FOR SELECTIVE AND SENSITIVE DETECTION OF HYDROCARBONS AND ACIDS,” the entire contents of which is incorporated herein by reference.

Related technology is disclosed in U.S. patent application Ser. No. 11/568,209 filed on Oct. 23, 2006, US having Publication Number 2007/0217973, published Sep. 20, 2007, PCT/US2005/016221 filed on May 10, 2005, published on Jun. 8, 2006 as publication number WO/2006/060032 and U.S. Provisional Patent Application Ser. No. 60/569,907 filed on May 10, 2004, of which the entire contents of each are incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Grant No. 5U01ES016064 awarded by the National Institute of Health.

### FIELD OF THE INVENTION

Exemplary embodiments of the present invention relate in general to an apparatus and method for sensing a change in environmental conditions. Exemplary embodiments relate more particularly to an apparatus and method of detecting toxic hydrocarbons and acid vapors.

### BACKGROUND OF THE INVENTION

Chemical sensors that can quickly, selectively and sensitively detect unknown chemicals in air or in water are vital for many purposes, ranging from security, environmental, biomedical and food and drinking water safety. Existing detection methods are divided into two categories, lab-based analytical methods, including various chromatographic and spectroscopic techniques, and handheld or portable chemical sensors. The methods in the first category are well established and have been used as the most reliable way to detect unknown analytes, but they are slow, expensive and bulky. Chemical sensors in the second category have a potentially huge market and are actively pursued by researchers around the world to enable faster, more efficient and less costly assessment of chemical information. However, the progress has been slow despite many claims in papers. While high sensitivity of a device is important, the most difficult problems are selectivity and reliability, especially when applying the device in real world environment. One of the most popular devices in the market is based on photoionization detection (PID), which faces the selectivity problem and falls short for many environmental health and safety applications.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Presenting a novel solution to a long felt and unsolved need, the present disclosure describes a method and apparatus to overcome selectivity and reliability problems found in the prior art. It contains several new, novel and useful features including: 1) Synthesis of a sensing material with high density of binding sites and excellent selectivity for toxic hydrocarbons and acid vapors; 2) Coating of the sensing material onto the surface of sensors, such as quartz crystal tuning forks; and 3) integration of the coated sensors with proper sample conditioning unit. The device achieves high sensitivity and selectivity, and has been tested in various field environments.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 illustrates an exemplary schematic representation of tuning fork sensors modified with a molecularly imprinted polymer (MIP) and modified hydrophobic ionic liquid (IL) blend for simultaneous detection of total hydrocarbons and acids.

FIG. 2 illustrates the sensitivity of commercial and home-made synthesized materials towards toluene.

FIG. 3 illustrates sensitivity of biphenyl molecularly imprinted polymer (BP-MIP) vs. highly hydrophobic commercial material: Wax (residual polycyclic aromatic and long alkyl hydrocarbon mixture from petroleum distillation, Apiezon), Mineral Oil (alkyl hydrocarbon mixture with C=20-40, Aldrich), Ionic Liquid: 1-butyl-3-methylimidazolium hexafluorophosphate, linear polystyrene (Aldrich).

FIG. 4 illustrates selectivity response of BP-MIP towards benzene and potential interference molecules.

FIG. 5 illustrates the selectivity of the acid sensing element tuned to avoid other groups of elements such as common inorganic gases (CO₂, CO, NO_{R}) and volatile organic compounds (VOCs) such as ethanol (eth.), acetone (ac.), aromatic hydrocarbons (benzene, toluene, ethylbenzene and xylenes; BTEX), and alkyl hydrocarbons (dodecane: doc.), while giving a high signal for strong acidic vapors such as hydrochloric acid and hydrogen sulfide.

FIG. 6 schematically illustrates a block diagram of an example of a detection device and system.

FIG. 7a-FIG. 7c schematically show a wearable monitor system for detection of total hydrocarbons and total acids.

FIG. 8a and FIG. 8b graphically illustrate intra-laboratory and extra-laboratory validation of the sensor results carried out against Gas Chromatography—Mass Spectrometry.

FIG. 9 schematically illustrates a test performed at the ASU Hazardous Waste Management Facility to check the exposure level of a worker involved in the disposal activity.

FIG. 10a illustrates a test performed to assess the exposure to cigarette smoke by a passive smoker in an indoor smoking area, and next to a smoker (see also picture and map).

FIG. 10b illustrates a test performed to evaluate an active smoker's exposure to cigarette smoke. The detection process included 10 seconds sampling and 50 seconds purging.

FIG. 11 illustrates a test performed during floor waxing activity at the Biodesign Institute, ASU.

FIG. 12 illustrates a test performed during a fire overhaul test in Phoenix to assess the exposure level of the fire workers during overhaul activities.

FIG. 13 illustrates a selectivity comparison of the wearable monitor (light grey bars) with a PID detector for the detection of ppb levels of volatile compounds (dark grey bars).

### DETAILED DESCRIPTION OF THE PREFERRED EMBODIMENTS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or various combinations or variations of these terms means that a particular feature, structure or characteristic described in connection with the embodiment is included in at least one embodiment of the present disclosure. Thus, the appearances of the phrases “in one example,” “in one example embodiment” or “in an embodiment” and similar phrases in various places throughout this specification are not necessarily all referring to the same embodiment. Furthermore, the particular features, structures, or characteristics may be combined in any suitable manner in one or more embodiments.

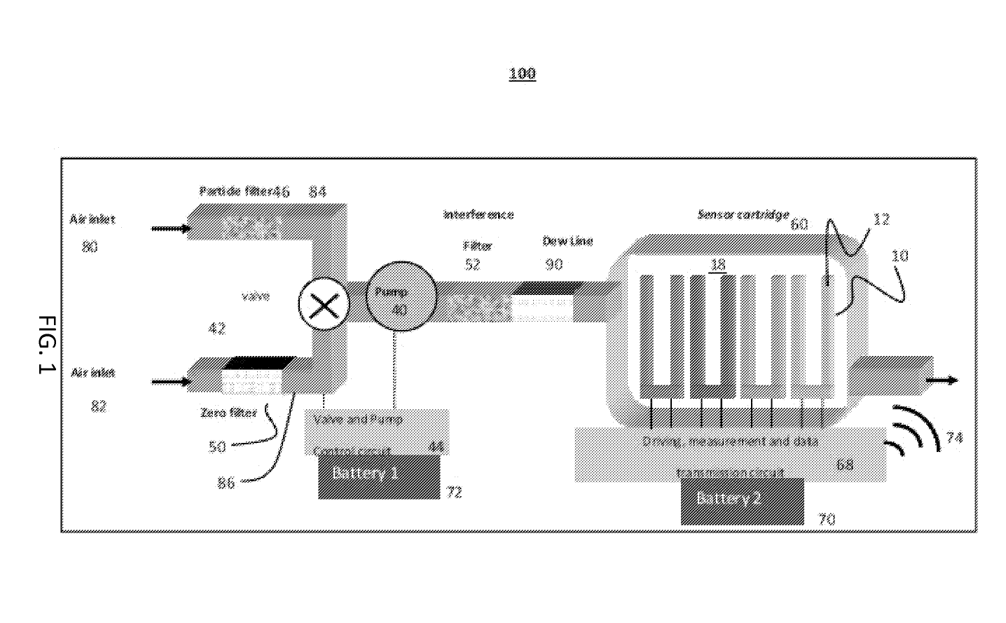

Referring now to FIG. 1, an exemplary schematic representation of tuning fork sensors modified with a molecularly imprinted polymer (MIP) and hydrophobic ionic liquid (IL) blend for simultaneous detection of total hydrocarbons and acids. In one example, a sample delivery and conditioning system 100 includes a pump 40, a valve 42, a valve and pump control circuit 44 powered by battery 72, and a plurality of filters 46, 50 and 52. A sensor cartridge 60 houses an array of different sensing elements 10, where different elements are adapted to sense environmental materials and conditions including, for example, hydrocarbons, acids, and humidity. The sensor cartridge is coupled to receive air flow from the pump 40. An interference filter 52 and a dew line 90 are interposed between the sensor cartridge 60 and the pump 40.

Also shown are at least two inlets 80, 82 for air, a sampling channel 84 and a purging channel 86. The former has an in-line particle filter 46 to prevent dust and other particulate matter from reaching the sensors 10, while the latter employs a zeroing filter 50 that absorbs all chemical species, resulting in clean air passing through. This is used to purge the system of residual analyte and interferent molecules after detection.

The sensor cartridge 60 may advantageously be coupled to a detection circuit 68. The detection circuit 68 is powered by a battery 70, which may comprise rechargeable Li-ion polymer batteries. In a useful embodiment the detection circuit is integrated with a chip for implementing an open wireless technology standard for exchanging data over short distances such as the commercially available under the trademark Bluetooth®. Transmission from the open wireless chip is indicated by transmission lines 74 where results may be transmitted to a user-friendly interface.

### Sensing Materials

Sensing materials that can perform simultaneous detection of analytes belonging to different families such as hydrocarbons and acids are described herein for chemical sensing applications. The materials are integrated to the sensors 10 to perform real-world environmental detections. In one example, the sensing material for hydrocarbons is based on a molecularly imprinted polymer (MIP). The sensing material for acids may be advantageously based on a highly hydrophobic and stable ionic liquid blend. Both sensing materials are intrinsically hydrophobic to avoid interference from environmental humidity, and integrated to a sensing platform (sensor array) that allows further performance improvements. The sensing materials may be integrated into a single device to achieve simultaneous detection of hydrocarbons and acids at outstanding detection limits of part-per-billion (ppb) levels or lower. The integration of the materials in a sensing device provides the possibility to detect analytes in gas and liquid phases in real time or close to real time.

In one example embodiment, the sensing elements 10 may advantageously comprise tuning forks. Tuning forks can be composed of quartz. Quartz crystal tuning forks are widely used for time-keeping devices, such as wristwatches. The use of quartz crystal tuning forks revolutionized the watch industry in the 1970s. Billions of quartz tuning forks are manufactured annually for time-keeping devices at a cost of a few cents each. Quartz tuning forks can be readily obtained from a myriad of commercial manufacturers such as ECS International, Inc. in Olathe, Kans. The widely available commercial quartz tuning fork used in cell phones is approximately two (2) millimeters long, approximately two-hundred (200) micrometers wide and approximately one-hundred (100) micrometers thick.

Sensing elements 10 are stable due to the relatively rigid structure of tuning forks. Commercial quartz tuning forks are well-packed with convenient electrical wiring options. Electrical circuits for driving and sensing the resonance of forks have been optimized and miniaturized over years of research and development by the watch industry and are well known.

Commercial quartz tuning forks can achieve a force sensitivity of a few pN (1 Hz bandwidth), which is much smaller than the force required to break a single covalent bond. The extremely high force sensitivity of fork makes it a preferable mechanism in Noncontact Atomic Force Microscopy to detect weak van der Waals forces.

Forks which are composed of quartz have additional distinctive features, which make them attractive for use in a chemical or biological sensor device. The quality factor (Q) of a quartz tuning fork often exceeds ten-thousand (10,000) in air due to the superior properties of quartz crystals. The large quality factor, together with the noise cancellation mechanism of two identical prongs in the forks, results in extremely high force sensitivity with minimal power dissipation. Quartz tuning forks are also astonishingly stable over time and temperature, which is the reason that the time deviation of even a cheap toy watch is no more than a few seconds a week.

### Sensing Material for Hydrocarbons

Molecularly Imprinted Polymers (MIPs) highly selective to hydrocarbons are synthesized by a method that produces a highly cross-linked polystyrene structure formed by divinylbenzene as functional group. Polymer binding sites are created using template molecules such as biphenyl (BP) or pyrene (Pyr) and porogen solvents such as benzene, toluene, ethylbenzene and/or o-, p-, m-xylenes. The synthesis is performed according to standard procedures and conditions published in Lieberzeit, P. A., et al.¹ Once the MIP is synthesized in the form of a block, a MIP micro/nanoparticulate solution is prepared before coating the material on the sensors. This is achieved with mechanical mashing and ultrasonic bath treatment. In some cases, linear polystyrene is used as a particle binder on the sensor to offer to the MIP more stability and adherence towards the sensing material. The MIPs provide distinctive features. (1) A high sensitivity due to a high density of binding sites provided by template and porogen-generated nanocavities in the polymer structure, and the high aspect ratio of the coated material. (2) A high selectivity towards the target analytes provided by the chemical nature of the polymer via multiple π-π and van der Waals interactions. (3) High affinity binding sites with selective but reversible binding, which enables multiple uses.

### Sensing Material for Acids

The blend created for acid vapor detection is a mixture of a hydrophobic ionic liquid (IL) and a strong base. ILs such as butyl-methyl-imidazole hexafluorophosphate (BMIM⁺-PF6⁻) and strong bases such as sodium hydroxide are suitable for this purpose. Blends of this nature offer two essential features: (1) high selectivity to strong acids, and (2) reduced influence against humidity changes.

### Preparation of the Sensors

In order to demonstrate the capability of the sensing materials to target selectively and sensitively the analytes, quartz crystal tuning forks²⁻⁶ (piezoelectric resonators) are used as mass sensitive sensors. However, any other sensing platform with a convenient transduction mechanism (e.g. quartz crystal microbalance, radio frequency tags) could be used for this purpose. The tuning forks are first coated with a hydrophobic layer by silanization of quartz-exposed areas with phenyltrimethoxysilane and thiolation of silver electrodes with dodecanethiol. This hydrophobic layer on the sensor is essential to acquire further immunity to environmental humidity changes. Subsequently, the tuning forks are coated with MIP solution or the IL blend. In the case of the IL blend, an additional layer of linear polystyrene is coated on the sensor to promote higher IL coating capability, which is traduced in higher sensor lifetime and lower detection limits.

### Integration of the Sensors in a Single Device

(1) Sensor array: The polymer/blend-modified tuning fork sensors are assembled in an array of sensing elements. In contrast to previous applications published by the inventors herein, the present disclosure teaches the use of the novel materials for simultaneous detection of hydrocarbons and acids at detection levels never reached before because of the unique sensing material preparation and implementation. This feature is enabled not only by the sensing materials but also by their integration into intrinsically high sensitive mass sensors (tuning forks) in combination with smart electronics and sample collection and conditioning systems into a single device. In the next sections we briefly describe the integration of the sensors that allows its use in field-testing applications.

When analyte molecules are present, they interact with the polymer or blend, binding onto it. For a film coating on a tuning fork, this causes a change in mass of the tuning fork. Since the coating is tuned to be selective to a specific chemical group, this results in a tuning fork sensor that is both selective and sensitive to target analytes. Experimental details of tuning fork sensor technology are described in previous publications.²⁻⁶ Briefly, tuning forks have a resonant frequency given by the equation (1):

$$f = \frac{1}{2 π} \sqrt{\frac{{k}^{′}}{M}} \qquad ( 1 )$$

where f is the resonant frequency of the tuning fork, k′ is the effective spring constant, and M is the effective mass. It can be seen from equation (1) that any change in effective mass will also cause a change in resonant frequency, which can easily be detected by digital electronics. We have characterized this behavior under different conditions and performed a calibration of resonant frequency change against analyte concentration.

(2) Sample collection and conditioning: As mentioned in the publications by NJ Tao et. al.,²⁻⁷ the sensors are securely placed inside a sensor cartridge made of Teflon® or other inert material. The cartridge has pin connectors that plug directly into the control circuit board, similar to the concept of “plug-and-play” devices. This cartridge offers many advantages: (A) fragile tuning fork sensors are protected against damage, (B) dead volume is extremely low (˜3.2 mL), and (C) due to the chemical inertness of Teflon, there is no interaction of analyte molecules with the walls of the cartridge itself.

Still referring to FIG. 1, apart from the sensors 10 and driving circuitry 68, the device has a separate system for handling the sample and directing the flow of air. In one example the device includes two inlets for air 80, 82, the sampling channel 84 and the purging channel 86. The former has an in-line particle filter to prevent dust and other particulate matter from reaching the sensors 10, while the latter employs a zeroing filter that absorbs all chemical species, resulting in clean air passing through. This is used to purge the system of residual analyte and interferent molecules after detection. The filters 42, 46 are connected to the valve 42 that receives a programmed signal to select which channel supplies air to the sensing elements and switches between them for predetermined intervals. This valve interval timing is programmable and can be changed as per requirements of purging and sampling time cycles. As mentioned in a former publication by Tsow, F. et al.⁶ the zeroing filter is composed primarily of activated carbon and sodium permanganate, while the particle filter is substantially composed of fibers coated with poly-methyl methacrylate (PMMA) solution. The PMMA coating prevents acid vapors from being absorbed by the fibers, and removes polar compounds from the air sample. The valve is followed by a pump, which draws air in from the selected inlet and forces it through the dew line 90. The inclusion of the dew line 90 in the system is a novel feature that allows the system to work in a wide range of environmental conditions, e.g. 0 to 100% relative humidity (non-condensing). In one useful example, the dew line 90 includes a nafion based tubing. It serves two functions. First, the dew line 90 brings humidity down to a constant value, and, secondly, it further removes polar-nature interferents. This further improves selectivity of the device beyond inherent selectivity of the polymer/blend-modified tuning fork sensor elements. After passing through the dew line 90, the air enters the sensor cartridge 60, where detection of the sample takes place.

(3) Detection Circuit (68) and valve and pump control circuit (44): Two printed circuit board (PCB) are used in the device to perform four main functions: (A) control of valve switching, (B) tuning fork drivers, (C) digitization of tuning fork responses, and (D) wireless data transmission and communication with a user interface module. The first function (A) is performed from a valve and pump control circuit (44), while functions (B), (C), and (D) are performed from the detection circuit (68). These features are designed in accordance with standard engineering principles.

(4) Signal Processing and User Interface Features: In one example, a cellular phone user interface was incorporated into a smart phone on a Windows Mobile platform. The application displays a real-time plot showing the responses of the different sensing elements. It also processes data that it receives from the device, greatly simplifying user interaction. To avoid false positives from long-term drift that sometimes occur with temperature changes, the application uses slope readings from the last quarter of the two-minute purging period as the baseline to calculate the response during sampling. There is also a feature to subtract the response of a control tuning fork from the response of the sensors. This eliminates false signals due to mechanical vibrations or potential sudden pressure changes.

Although the device is versatile and works in different kind of environments, suitable implementation scenarios are occupational health and safety settings, environmental exposure assessment, firefighting activities, and the like.

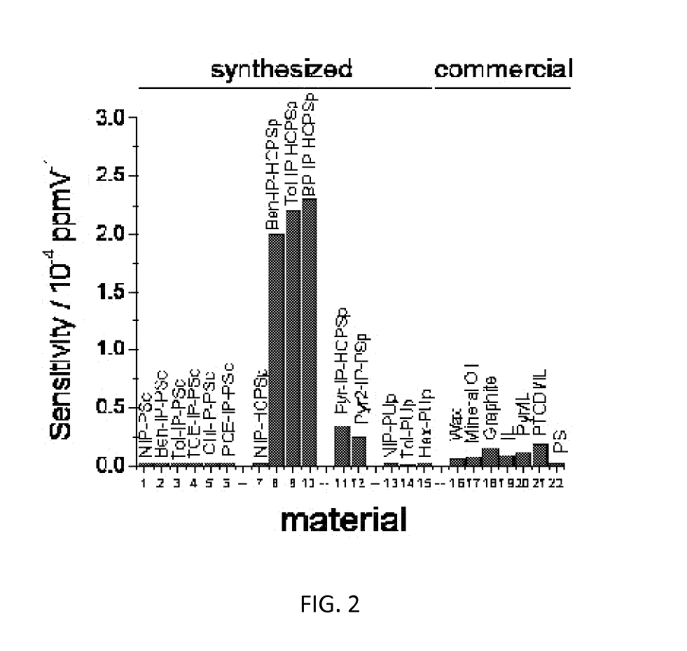

Referring now to FIG. 2 the sensitivity of commercial and home-made synthesized materials towards toluene is graphically illustrated. The materials were cast on tuning fork sensors (TF) used as sensors. As plotted in a 2D Cartesian coordinate system the x-axis specifies mass coating normalized sensitivity/10⁻⁴ ppmV⁻¹ and the y-axis specifies materials including synthesized and commercial materials. Sensitivity values were obtained from the TF response normalized by analyte concentration and coating mass (ppmV⁻¹).

1. Screening of Commercial and Synthesized MIPs

Commercial polymers and synthesized materials were casted on the sensing surfaces of the tuning forks (TF) and their responses to several toxicant hydrocarbons benzene (Ben), toluene (Tol), xylenes (EX), hexane (Hex), dodecane (Do), chloroform (Chl), trichloroethylene (TCE), perchloroethylene (PCE)) were studied. The synthesized materials included non-imprinted (NI) and molecularly imprinted (MIP) polymers based on polystyrene (PS) and polyurethane (PU), in the forms of uniform coating (c) or micro/nanoparticle-coating (p). Several molecules were used as templates of MIPs (e.g.: Ben, Tol, biphenyl (BP) and pyrene (Pyr). FIG. 2 summarizes the sensitivity of the most relevant results (toluene is used as target analyte), showing that the MIPs-based on highly cross-liked polystyrene micro/nanoparticles (HC-PSp) were the best.

2. Sensitivity of MIP vs. Highly Hydrophobic Commercial Materials

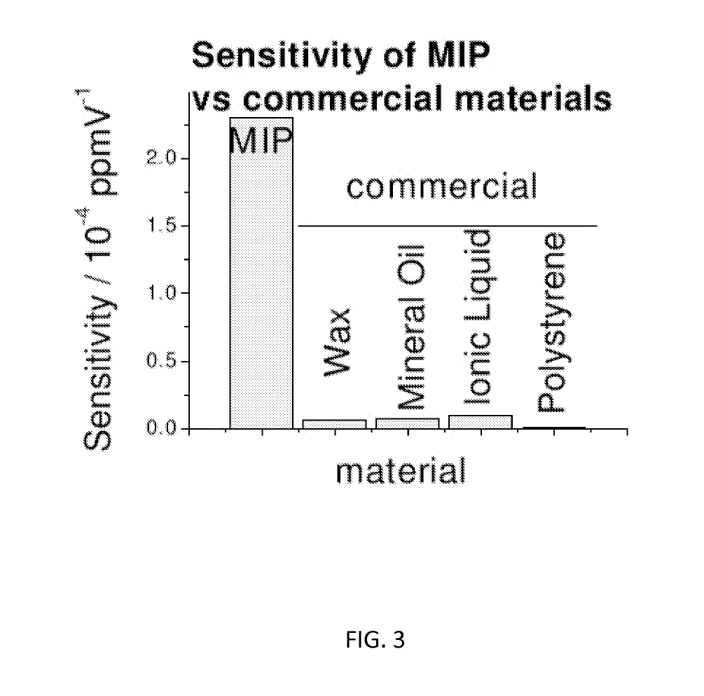

Referring now to FIG. 3 coating mass normalized sensitivity of BP-MIP vs. highly hydrophobic commercial material is illustrated: Wax (residual polycyclic aromatic and long alkyl hydrocarbon mixture from petroleum distillation, Apiezon), Mineral Oil (alkyl hydrocarbon mixture with C=20-40, Aldrich), Ionic Liquid: 1-butyl-3-methylimidazolium hexafluorophosphate, linear polystyrene (Aldrich).

As illustrated by the bar chart, the sensitivity of the new created MIP micro/nanoparticulate coatings towards hydrocarbons detections were compared with other existing commercial materials. The new coatings were at least 20 times more sensitive. Thus, an MIP coated sensor can achieve real-time detection of hydrocarbons at ppb levels.

3. Selectivity of MIP Against Common Interferents

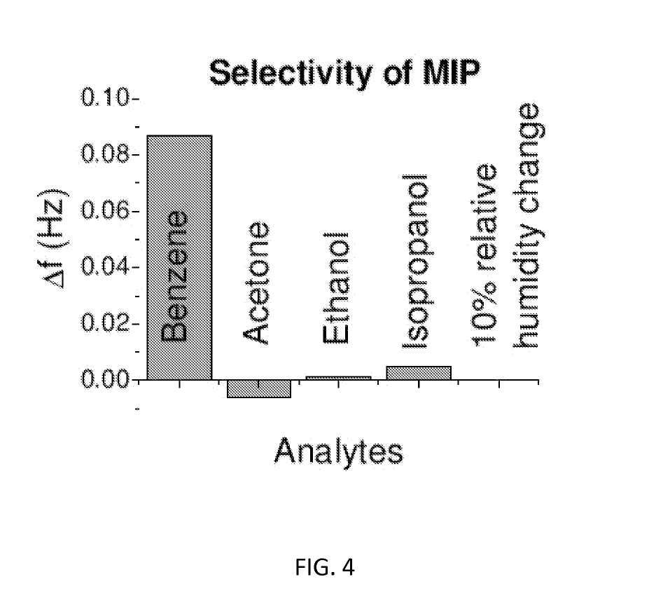

Referring now to FIG. 4 selectivity responses of BP-MIP towards xylenes (ethylbenzene, o, m, p-xylenes) and potential interference molecules is illustrated. Excepting humidity, the analyte and interferent concentrations are 40 ppmV. The selectivity of an MIP coated sensor was tested against humidity, regular polar molecules, person's breathing zones, and personal care and household products. FIG. 4 shows, for example, a result from the test against common chemicals. High detection selectivity is observed towards benzene, which is an aromatic hydrocarbon well known by its toxicity and carcinogenesis.

4. Acid Sensor Performance

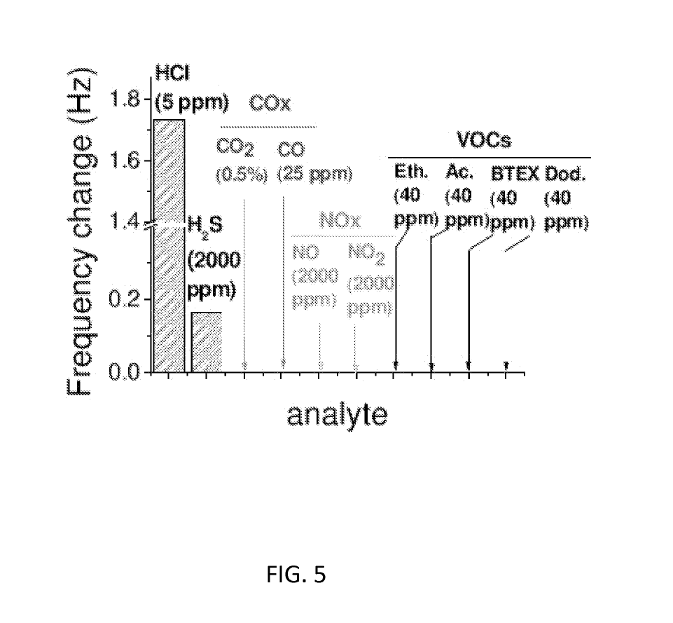

Referring now to FIG. 5 the selectivity of the acid sensing elements is tuned to avoid other groups of elements such as common inorganic gases (CO2, CO, NOx) and volatile organic compounds (VOCs) such as ethanol (eth.), acetone (ac.), aromatic hydrocarbons (BTEX), and alkyl hydrocarbons (dodecane: doc.), while giving a high signal for strong acidic vapors such as hydrochloric acid and hydrogen sulfide is illustrated. In order to characterize the selectivity of the acid sensor, the sensor was exposed to acids, regular environmental gases and volatile organic compounds. From this group, only strong acidic vapors such as hydrochloric acid and hydrogen sulfide are detected by the sensor.

### Detection System

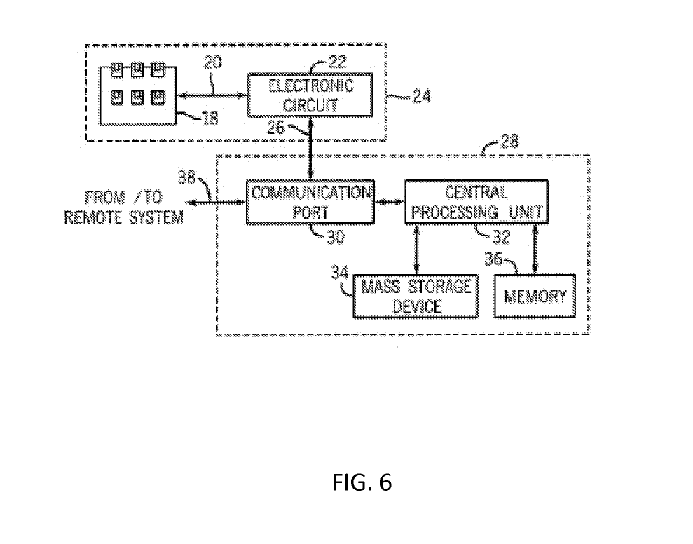

Turning to FIG. 6, (from US2007/0217973) a block diagram of a possible detection device and system is shown. Array 18 is again shown, electrically coupled 20 to electronic circuit 22. Local controller 24 can encompass array 18, electronic coupler 20 and electronic circuit 22. Electronic circuit 22 may be manufactured or supplied as an integrated or separate component from array 18. Electronic circuit 22 can include a variety of interrelated electrical components such as resistors, capacitors and transistors, which are integrated into a printed circuit board (PCB) or similar technology. Array 18 can be designed to simply plug into a PCB or related electronic component. Local sensor device 24 may include such integrated electronic components as amplifiers or filters which are located as part of the electronic circuit 22. The electronic circuit 22 can have integrated electronic components described above which are embedded in conventional microchip or similar technology.

In one embodiment, an AC modulation may be used to drive array 18 into resonance. The electrical outputs of array 18 can be amplified with a current amplifier located as part of the electronic circuit 22. The output of the current amplifier can then be sent to a lock-in amplifier, also located as part of the electronic circuit 22. The frequency of the AC modulation can be linearly swept within a range that covers the resonance frequencies of all the forks 10 in array 18. The output from the lock-in amplifier may be recorded as a function of frequency with sufficient resolution to provide a spectrum of the entire array 18.

Local controller 24 can include a power supply such as a battery in order to drive array 18 into resonance and supply power to amplify, filter, or otherwise analyze the electrical outputs of array 18. The power supply can be located as part of electronic circuit 22 or elsewhere on local controller 24.

Electronic circuit 22 can send or receive electrical signals or other communication information through link 26 to a larger system 28. System 28 can be a workstation, desktop, notebook, personal digital assistant, cellular phone or other computer. System 28 includes communication port 30, which receives information and/or electrical signals from the electronic circuit 22. System 28 can also include central processing unit 32, mass storage device 34 and memory 36. System 28 can have associated software, which translates incoming raw electrical signals or information passed through link 26 into manageable information which is displayed or seen on a graphical user interface (GUI) or similar device. System 28 may pass raw or processed electrical signals or information through link 38 to an external system for viewing or further processing.

Local controller 24 may be integral to system 28, or can be external to system 28. Electronic circuit 22 located on local controller 24 may include electrical components necessary to convert electrical signals to radio frequencies. Link 26 can, in turn, be a wireless connection between system 28 and local controller 24, such as IEEE 802.11a/b/g wireless protocols or equivalent. Local controller 24 can include a hand-held, wrist-worn device or the like.

In an example of using local controller 24 and system 28, a user may place local controller 24 on his wrist. Local controller 24 can include array 18, which has tuning forks 10 which have been selected, designed and calibrated to identify chemical analytes of chemicals known to be present in and around selected analytes. A user may wear local controller 24 as part of the user's occupation, where local controller 24 is continually powered and constantly monitoring the air, such as a customs officer who inspects arriving goods.

Local controller 24 may have onboard memory as part of the individual components of electronic circuit 22. When a change in resonant frequency, amplitude or quality factor is determined by local controller 24, associated software located on local controller 24 can check the frequency response against a library or database located in the onboard memory of local controller 24. When a match is detected, an alarm can be triggered. Similarly, local controller 24 can communicate wirelessly with system 28 through link 26 to provide, for example, a daily summary of any trigger events. The trigger events can be logged by system 28 or transmitted to an external system through link 38 for further analysis. System 28 can include onboard software, which can log trigger events as described, analyze a frequency response or determine a change in amplitude. The onboard software can be adapted to efficiently determine frequency shifts or amplitude changes for a particular use, environment and type or groups of analytes to be detected. The onboard software can be commercially obtained and can include algorithms and methods generally known in the art.

Several applications to field-testing of the sensing materials and their integration into a sensing device are described below. Simultaneous detection of hydrocarbons and acids is demonstrated at ppb levels in real-time. In the case of acid detection, the sensor over performs with respect to the reference detection method by NIOSH (NIOSH method 7903).

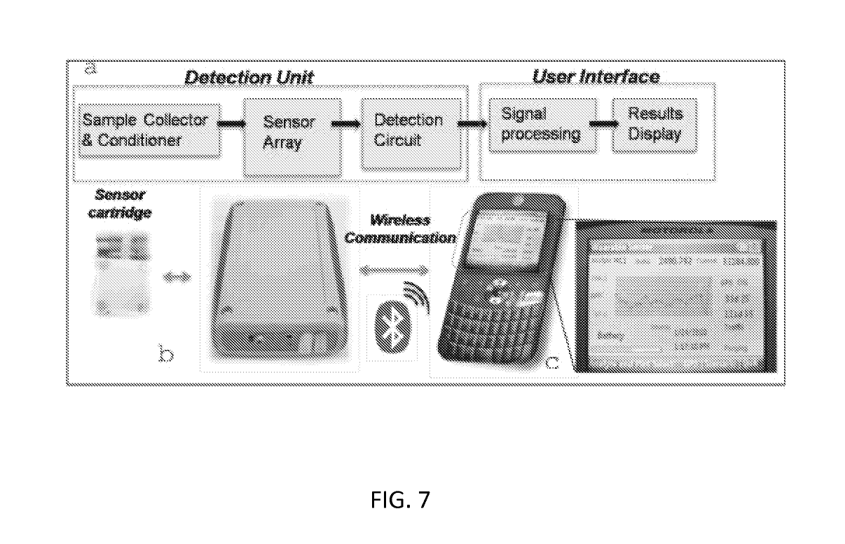

Referring now to FIG. 7a-FIG. 7c a wearable monitor system for detection of total hydrocarbons and total acids is schematically shown. FIG. 7a shows a block diagram of functions performed by the detection unit and user interface. FIG. 7b shows pictures of the plug-and-play sensor cartridge with a tuning fork array; the wireless hand-held unit wirelessly connected to a Motorola brand Q9h smart phone, which processes the data, stores and displays the detection results. FIG. 7c shows an example of the cell phone display, showing a real-time concentration plot (ppb levels vs. time), GPS data, active displayed sensing element hydrocarbon sensor 1 (HCl), active application (traffic) and valve status (purging).

The wearable monitor unit weighs ˜0.5 lbs with a size comparable to a smart cell phone, making it possible to be either handheld or wearable near the breathing zone. The unit includes a sample collection, conditioning and delivery system, a sensor cartridge, a detection and control electronic circuit, operated with batteries. These components are integrated into a complete system and operate together synergistically to provide the superior performance. For example, the high sensitivity is achieved by using not only a highly sensitive microfabricated tuning fork array in the sensor cartridge, but also low noise detection circuit that allows for accurate detection of the resonant frequencies of the array. The high selectivity is a result of both the selective sensing materials and optimized sample conditioning system.

The sensor cartridge is a plug-and-play component that offers flexibility to detect different types of target analytes simultaneously. The sensor cartridge used in the present work is an array of quartz crystal tuning fork resonators optimized for selective detection of total hydrocarbons, total acids, humidity and temperature. The sensors are securely placed inside a sensor cartridge made of Teflon®. The cartridge has pin connectors that plug directly into the control circuit board. The detection circuit is based on a high-resolution frequency counter (0.2 mHz) and provides an equivalent mass detection limit of ˜1 pg/mm². The synergic architecture of the sensing materials, smart electronics, and signal processing allows the detection of part-per-billion volume (ppb) levels of total hydrocarbons and acids. The wearable unit is powered by Li-ion polymer batteries and can be recharged by simply plugging it into a power outlet.

Power distribution and hardware optimization ensure continuous operation of the wearable unit over nine hours. In addition, the detection circuit has a Bluetooth®□chip for real-time data transfer to the cell phone.

### Cell Phone-Based User Interface

The cell phone receives the data from the wearable monitor, processes the information and displays the data via a graphic user interface. The data is stored in the cell phone that can be downloaded to a computer later, or emailed via the existing wireless service. In addition to reading, processing and displaying toxicant levels, the cell phone can also record the embedded GPS location. The interactive graphic user interface allows the user to access and view detailed detection information, such as real-time data for each sensing element of the array, different analytes, and operation status of the monitor (pump, valves and battery life, etc.). Another useful feature is that the user can select between different application scenarios (e.g. industrial solvent, motor vehicle emission, etc.) for hydrocarbon assessment. Each scenario has a calibration factor that best suits the chosen environment. A typical industrial or occupational activity involves exposure to a dominant hydrocarbon, which can be determined by the corresponding calibration factor. Exposures to more complex environments, such as emissions from motor vehicles, gasoline and petrochemical industries, require calibration factors that reflect the distribution of the hydrocarbons and the sensitivity of each hydrocarbon (Brown, Frankel et al. 2007).

Exposure assessment in these scenarios is important for many epidemiologic studies (McConnell 2008).

### Analytical Validation

To examine the accuracy of the wireless wearable system, we performed intra- and inter-laboratory validations described below:

The intra-laboratory validation tested the sensitivity and selectivity of the system using gas chromatography-mass spectrometry (GC-MS) as a reference method for hydrocarbons, and recovery assays for acids. It also serves the purpose of establishing and testing the calibration factors for the different application scenarios described above. The validation for hydrocarbon detections was implemented by following a parallel sampling methodology. Air samples were collected from test locations in a 1 or 4 L Tedlar® bag while the wearable system was measuring the air at the same location. The collected air sample was then brought to an analytical lab and analyzed using a HP 5890/5972 Quadrupole GC-MS. The GC-MS method was optimized for detecting low concentration aromatic and aliphatic hydrocarbons. The hydrocarbons in the sample were preconcentrated in a 100-μm polydimethylsiloxane-coated solid phase microextraction fiber (SPME) for a period of 1 h, and then placed into a 0.75-mm diameter glass injector. The hydrocarbons adsorbed in the SPME fiber were released in the GC injector by raising the temperature to 290° C. The separation used 30 m×250 μm×0.25 μm HP-5MS capillary column coated with 5% phenyl methyl siloxane. The analysis started with the temperature set at 40° C. After 2 minutes, the column temperature was raised to 100° C. at 4° C./min and then to 295° C. at 10° C./min. The entire sample analysis lasted ˜38 minutes. Identification of the analytes was performed using known standards and the mass spectrum library from NIST (AMDIS32 software). The total hydrocarbon level was obtained by adding up the individual hydrocarbons determined from the chromatogram, which was used to compare and calibrate the readings of the wearable monitor.

To calibrate the acid detection capability of the wearable monitor, standard acid gas vapors were used. After calibration, the monitor was further validated using real samples spiked with known concentrations of acid gases (e.g., different concentrations of hydrochloric acid). Inter-laboratory validation was carried out in collaboration with the Department of Environmental Health and Safety (EHS) at Arizona State University (ASU). The wearable monitor was used to detect toxic hydrocarbons and acid vapors, and the samples were collected from the sites and shipped to a third-party laboratory (Galson Laboratories, Syracuse) for analysis using NIOSH methods. For example, NIOSH method 1005 (NIOSH1005) was used to quantify methylene chloride hydrocarbons (dominant component in the samples). The procedure included air sample collection using a solid sorbent (coconut shell charcoal tube, 100/50 mg), desorption of the sample in 1 mL of CS2, and analysis with a GC-Flame Ionization system. NIOSH method 7903 (NIOSH7903) was utilized for acid vapors. In this case, the solid sorbent was washed silica gel (400 mg/200 mg glass fiber filter plug), the desorption took place in 10 mL of 1.7 mM NaHCO3/1.8 mM Na2CO3 solution, and the analysis used 50 μL of the solution in an ion chromatography system.

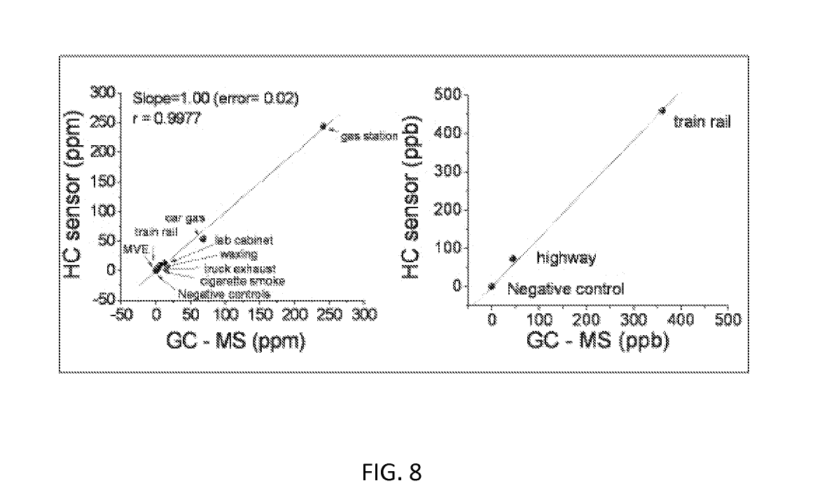

FIG. 8 graphically illustrates intra-laboratory validation of the sensor results carried out against Gas Chromatography—Mass Spectrometry.

### Intra-Laboratory Validation

FIG. 8 compares the hydrocarbon levels determined by the monitor and by GC-MS for samples taken at different locations, including airport, gas stations, laboratory cabinets, truck exhaust exposure, cigarette smoke, car gas (open tank), train rail, floor waxing, and motor vehicle emissions (MVE) in a highway.

Because the hydrocarbon levels at these locations vary over a wide range, from a few tens of ppb to several hundred part-per-million (ppm), we present the results in two plots. The comparison shows a high degree of correlation (100%) with a relative error of 2% and a regression factor of 0.9977 over the wide dynamic range. We also performed acid detection validation and found accuracy within 95-105%.

### Inter-Laboratory Validation

The test was carried out with the help of industrial hygienists in EHS, ASU, during dumping of organic and acid hazardous wastes. The waste disposal involved mostly methylene chloride and low percentages of chloroform and toluene. The concentration of methylene chloride determined by a certified laboratory (Galson Laboratories) was 2.2 ppm, while the average concentration detected by the wearable monitor during the same sampling period was 2.6 ppm. Considering that the wearable monitor measured not only methylene chloride, but also components, such as chloroform and toluene, the agreement is reasonable. The acid levels determined by the NIOSH method were below the detection limit, which ranges between 0.06-0.3 ppm depending on the type of acid. The average acid level measured by the wearable monitor in the same testing period was 0.012 ppm, which is consistent with the results by the NIOSH method.

Field Testing

Several field tests under different scenarios were carried out and the findings are summarized below.

### Case Study 1: Hazardous Waste Exposure at the ASU Waste Management Facility

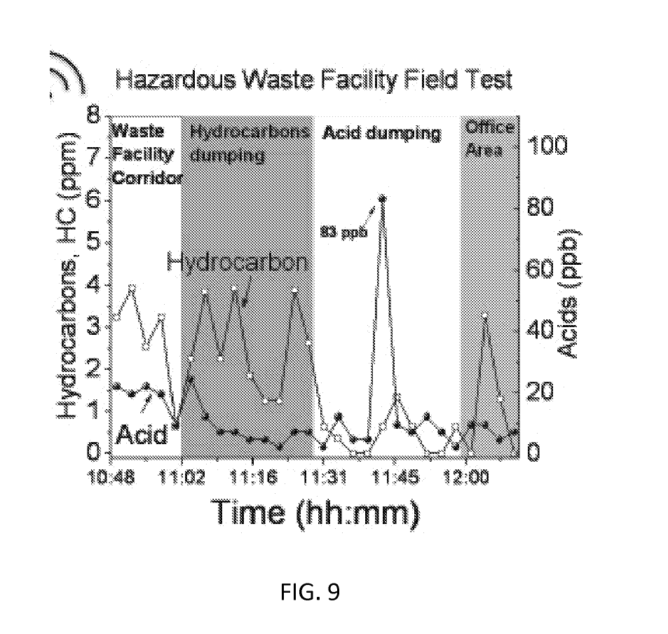

Waste management facility and chemical laboratories are potential sources of concern for health and safety of workers (Xu and McGlotin 2003). Poor ventilation and air quality inside a waste management facility are leading causes of serious illness and loss of productivity in these workplaces. Continuous monitoring of hazardous toxicants is therefore an essential part of health and safety that could make a significant impact (Je, Stone et al. 2007). We demonstrated that the wearable monitor could provide effective monitoring of hazardous toxic exposures at these sites. FIG. 9 schematically illustrates a test performed at the ASU Hazardous Waste Management Facility to check the exposure level of a worker involved in the disposal activity. The sensor was able to detect real-time short-term exposure levels (in 1 minute intervals). The highest acid level was detected during acid dumping, while the highest solvent exposure levels occurred during solvent dumping (ventilated) and in other places of the facility. The detection process included 1 minute sampling and 2 minutes purging. The hydrocarbon level reached nearly 4 ppm at three different occasions during organic solvent dumping activity, while the average exposure level of the entire activity was only 2.6 ppm. This important short-term exposure information was possible only by using the real-time monitor with adequate time resolution. Similar real-time detection of acid exposure detected peak values of 0.083 ppm. This level of acid cannot be detected using the current NIOSH methods, demonstrating the superior sensitivity of our wearable monitor.

### Case Study 2: Cigarette Exposure Study

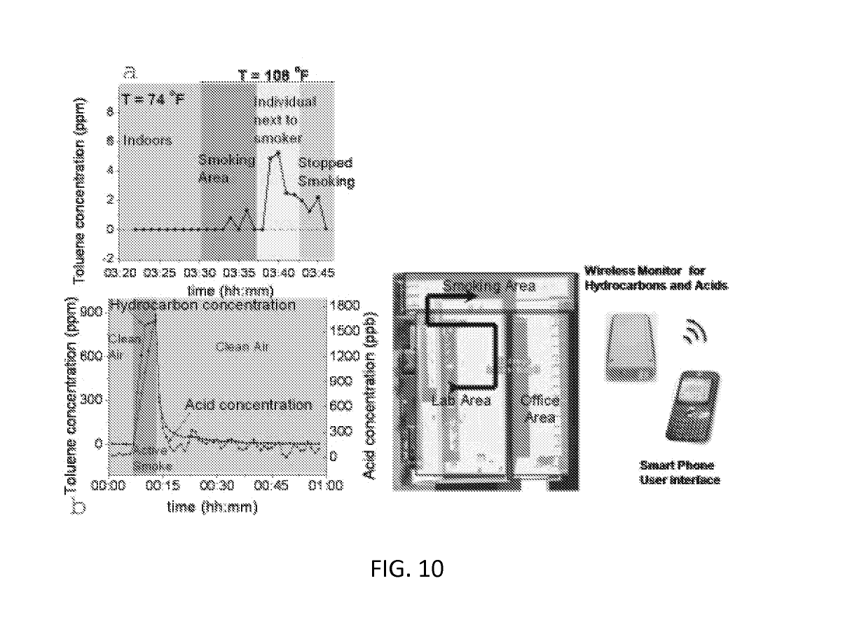

FIG. 10a illustrates a test performed to assess the exposure to cigarette smoke by a passive smoker in indoor (lab area), smoking area, and next to a smoker (see also picture and map). Cigarette smoke exposure has been identified as one of the major sources of unintentional exposure to carcinogens. A recent study by Carrieri et al. (Carrieri, Tranfo et al.) indicates that smokers are exposed to more benzene than non-smokers working at petrochemical industries. This finding has motivated epidemiologists, toxicologists and air-quality researchers to study health consequences of general public exposure at smoking places (Sleiman, Gundel et al. 2010). Specific components of cigarette smoke were first characterized by GC-MS, which identified hydrocarbon components detected by our wearable monitor. The study showed that although cigarette smoke is a complex mixture of gases, only aromatic hydrocarbons, such as toluene, and benzene were detected. As an example, FIG. 10a shows the exposure of a non-smoker wearing the monitor in the front pocket located near the breathing zone. When the non-smoker passed a smoking area, the second hand exposure to hydrocarbons increased from the background noise (a few ppb) to 1.5 ppm. The exposure level reached as high as 5.2 ppm when the non-smoker sat next to an active smoker. The exposure level of the active smoker was also monitored with the wearable monitor, FIG. 10b illustrates a test performed to evaluate an active smoker's exposure to cigarette smoke. The detection process included 10 seconds sampling and 50 seconds purging. Exposure measurement on active smokers measured 2 orders of magnitude higher hydrocarbon levels than the second-hand smoker. The exposure hydrocarbon levels of the firsthand smoker determined here are in good agreement with the previously reported values in literature (Hatzinikolaou, Lagesson et al. 2006). Note that the wearable monitor also measured the acid levels, which were in the range of several hundred ppb. The sources of the acid levels are likely due to hydrochloric acid, hydrogen cyanide and hydrogen sulfide (Bolstad-Johnson, Burgess et al. 2000; Parrish, Lyons-Hart et al. 2001; Hatzinikolaou, Lagesson et al. 2006). Note also that the test was carried out during summer in Phoenix, with outdoor temperature as high as 108° F. (42.2° C.), which demonstrates the robustness of the monitor.

### Case Study 3: Exposure of Cleaning Workers

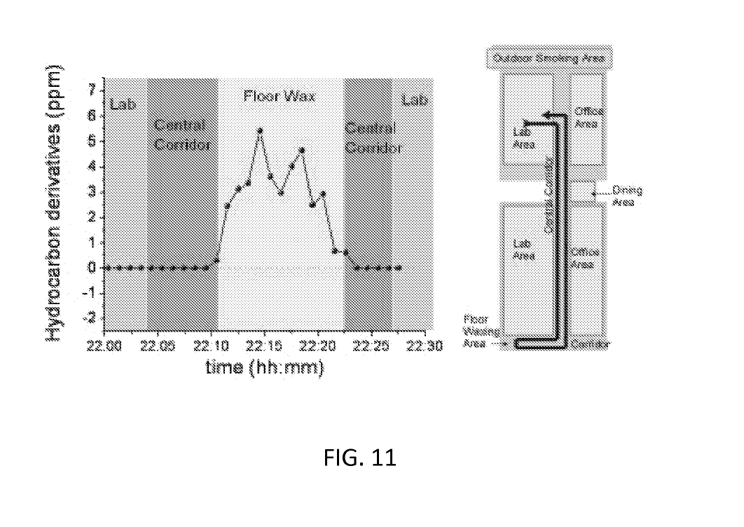

Higher work-related asthma risk has been reported for cleaning workers (Obadia, Liss et al. 2009). The activities of these workers include waxing floors, cleaning carpets, tiles and grout. We monitored the exposure levels of hydrocarbons during floor waxing activities with the wearable monitor. FIG. 11 illustrates a test performed during floor waxing activity at the Biodesign Institute, ASU. High concentrations of hydrocarbons were obvious in the area where floor waxing was taking place. The map on the right displays the path followed during the test by the worker wearing the monitor. The detection process included 10 seconds sampling and 50 seconds purging. The hydrocarbon level increased above 6 ppm when the person approached the floor waxing area, and the reading returned to nearly zero (<a few ppb) when the person left the waxing area. The test demonstrates again the capability of the wearable monitor for real-time monitoring of toxicant levels in a microenvironment.

### Case Study 4: Exposure Assessment of Fire Overhauls Activities

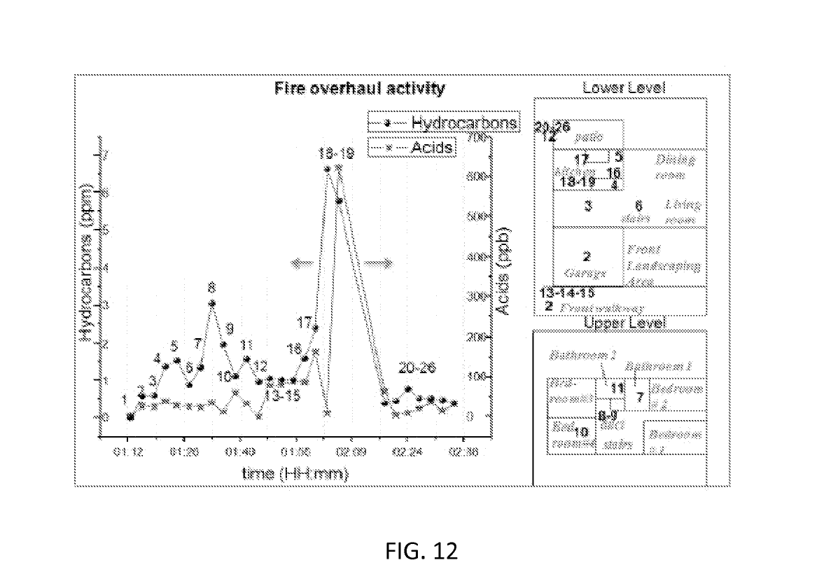

Fire overhaul is the phase after a fire has been extinguished. This is the time period when firefighters seek for potential re-ignition spots and arson investigators explore the potential source of the fire. Exposure of fire workers during overhaul activities has been studied by Burgess et al (Bolstad-Johnson, Burgess et al. 2000; Burgess, Nanson et al. 2001). Several toxicants, such as aromatic hydrocarbons (benzene), acids (hydrochloric acid), and aldehydes (formaldehyde) have been found to be present in these environments (Bolstad-Johnson, Burgess et al. 2000). Another important point is the way the monitor can aid arson investigators tasks (Burgess and Crittenden 1995). The current method used by the fire investigation team for this activity commonly involves the collection of the air sample on a sorbent tube for a long duration and its analysis by a certified laboratory later, which only provides averaged concentration. In collaboration with Phoenix Fire Department, the wearable monitor was used to map toxicant levels in fire overhauls. FIG. 12 illustrates a test performed during a fire overhaul test in Phoenix to assess the exposure level of the fire workers during overhaul activities. Highest exposure levels were detected in the duct of the house, a source of the toxic gases (8), and in the place where the fire was suspected to have started (18-19). The detection process included 1 minute sampling and 2 minutes purging.

The monitor allowed fire the investigator to map the concentrations of toxicants. Before entering the burnt down house, the hydrocarbon and acid levels were nearly zero (1). The toxicant levels increased as soon as the arson investigator entered the front walkway (2) of the house. A point of interest in this house was the air conditioning duct where ˜3.3 ppm level of hydrocarbons was detected (8). The monitor detected the highest concentrations of hydrocarbons (˜7 ppm) and acids (˜600 ppb) in an area pointed out by the arson investigator as the origin of the fire (18-19). One interesting observation was that toxicant levels showed strong correlations with the location and distance from burnt objects. Another interesting observation was that burnt places containing furniture, decorative ornaments, carpets and other objects showed high levels of toxicants and thus represented greater exposure risks to firefighters and arson investigators.

Comparison of the Wearable Monitor to Existing Technologies

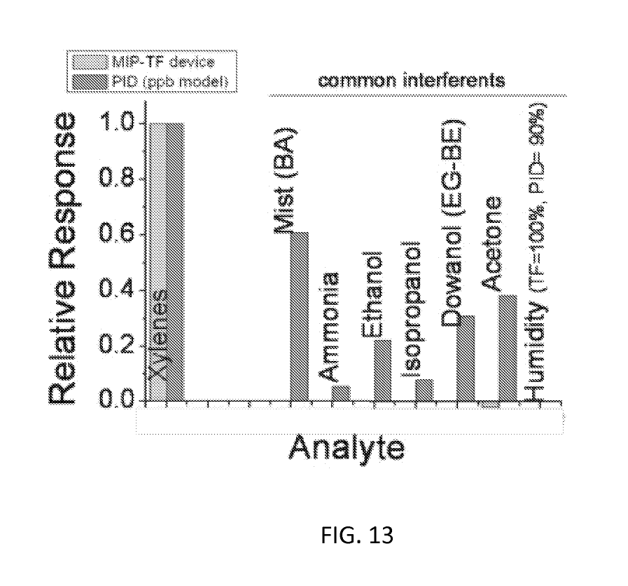

The performance of our wearable monitor was compared with a commercial photoionization detector (PID) using a 10.6 eV UV lamp to detect ppb levels of volatiles compounds. FIG. 13 illustrates a selectivity comparison of the wearable monitor (light grey bars) with a PID detector for the detection of ppb levels of volatile compounds (dark grey bars). The interferents are mist or its equivalent fragrance molecule—benzyl acetate (BA), ammonia, ethanol, isopropanol, dowanol or its parent molecules—ethyleneglycol (EG) or butyleneglycol (BE), acetone, and humidity. Note that the wearable monitor is immune even to 100% relative humidity, while the manufacturer of the PID specifies a maximum of 90% relative humidity.

PID-based monitor is capable of ionizing volatile compounds from different families, including alcohols, ketones and ammonia, but it cannot ionize some hydrocarbons, such as short alkyl hydrocarbons that are constituents of diesel and gasoline. Unlike the PID detectors, the wearable monitor is more selective for the detection of toxic hydrocarbon derivatives from the petroleum products and immune to interferents, such as alcohol, ketones, and ammonia. The graph shows a comparison of the selectivity of our monitor with the PID detector. The PID detector detects total volatile compounds exposure, including the interferents, and our wearable monitor targets specifically hydrocarbon compounds from petroleum including benzene, toluene, xylenes, and short and long alkyl hydrocarbons. These hydrocarbons are ozone precursors, which are important to respiratory health (EPA).

The new proposed materials and its use into a single sensing device overcome many drawbacks from commercial existing methods, including strong competitors such as PID detectors. They enhance the selectivity and reliability for real-time detection of the analytes in complex matrices, including the presence of high concentration of interferences. The following mayor advantages are:
At sensing material level: Improvement of selectivity, sensitivity and reliability for simultaneous detection of the target analytes from different families (hydrocarbons and acids), with a decreasing false positive and false negative responses of the sensor.
At chemical sensor level: The use of quartz crystal tuning forks as mass sensors adds the intrinsic mass detection sensitivity that furthers improves the detection limits of the analytes.
At chemical sensing device level: The use of an integrated sensing system in a device allows real-time detection of the analytes, at extreme environmental conditions such as 100% relative humidity changes.

While one or more embodiments of the present invention have been illustrated in detail, the skilled artisan will appreciate that modifications and adaptations to those embodiments may be made without departing from the scope of the present invention as set forth in the following claims.

### REFERENCES

The teaches of the following listed references are incorporated herein by reference.
1. Lieberzeit, P. A.; Gazda-Miarecka, S.; Halikias, K.; Schirk, C.; Kauling, J.; Dickert, F. L. Sensors and Actuators B: Chemical 2005, 111-112, 259.
2. Ren, M. H.; Tsow, T.; Forzani, E. S.; Tao, N. J., Cell phone tuning fork sensor array for the detection of chemical vapors. Abstracts Of Papers Of The American Chemical Society 2005, 229, 396.
3. Tsow, F.; Forzani, E. S.; Tao, N. J., Frequency-coded chemical sensors. Analytical Chemistry 2008, 80, (3), 606-611.
4. Wang, R.; Tsow, F.; Zhang, X. Z.; Peng, J. H.; Forzani, E. S.; Chen, Y. S.; Crittenden, J. C.; Destaillats, H.; Tao, N. J., Real-Time Ozone Detection Based on a Microfabricated Quartz Crystal Tuning Fork Sensor. Sensors 2009, 9, (7), 5655-5663.
5. Rai, A.; Tsow, F.; Nassirpour, S.; Bankers, J.; Spinatsch, M.; He, M. P.; Forzani, E. S.; Tao, N. J., Selective detection of sulfur derivatives using microfabricated tuning fork-based sensors. Sensors And Actuators B-Chemical 2009, 140, (2), 490-499.
6. Tsow, F.; Forzani, E.; Rai, A.; Wang, R.; Tsui, R.; Mastroianni, S.; Knobbe, C.; Gandolfi, A. J.; Tao, N. J., A Wearable and Wireless Sensor System for Real-Time Monitoring of Toxic Environmental Volatile Organic Compounds. IEEE Sensors Journal 2009, 9, (12), 1734-1740.
7. R. A. Iglesias, F. Tsow, R. Wang, E. S. Forzani*, N. J. Tao*, “A hybrid separation and detection device for analysis of BTEX in complex samples”, Analytical Chemistry, 2009, 81 (21), 8930-8935.
8. Bolstad-Johnson, D. M., J. L. Burgess, et al. (2000). “Characterization of firefighter exposures during fire overhaul.” Aihaj 61(5): 636-641.
9. Brown, S. G., A. Frankel, et al. (2007). “Source apportionment of VOCs in the Los Angeles area using positive matrix factorization.” Atmospheric Environment 41(2): 227-237.
10. Burgess, J. L. and J. C. Crittenden (1995). “Tucson firefighter exposure to products of combustion; A risk assessment.” Appl Occup Environ Hyg 10: 37-42.
11. Burgess, J. L., C. J. Nanson, et al. (2001). “Adverse respiratory effects following overhaul in firefighters.” Journal Of Occupational And Environmental Medicine 43(5): 467-473.
12. Carrieri, M., G. Tranfo, et al. “Correlation between environmental and biological monitoring of exposure to benzene in petrochemical industry operators.” Toxicology Letters 192(1): 17-21.
13. Chambers, D. M., B. C. Blount, et al. (2008). “Picogram measurement of volatile n-alkanes (n-hexane through n-dodecane) in blood using solid-phase microextraction to assess nonoccupational petroleum-based fuel exposure.” Analytical Chemistry 80(12): 4666-4674.
14. EPA http://www.epa.gov/appcdwww/apb/mobile.htm.
15. Gaertner, R. R. W. and G. P. Theriault (2002). “Risk of bladder cancer in foundry workers: a meta-analysis.” Occupational And Environmental Medicine 59(10): 655-663.
16. Hatzinikolaou, D. G., V. Lagesson, et al. (2006). “Analysis of the gas phase of cigarette smoke by gas chromatography coupled with UV-diode array detection.” Analytical Chemistry 78(13): 4509-4516.
17. Je, C. H., R. Stone, et al. (2007). “Development and application of a multi-channel monitoring system for near real-time VOC measurement in a hazardous waste management facility.” Science Of The Total Environment 382(2-3): 364-374.
18. Jo, W. K. and C. H. Yu (2001). “Public bus and taxicab drivers' exposure to aromatic work-time volatile organic compounds.” Environmental Research 86(1): 66-72.
19. LeMasters, G. K., A. M. Genaidy, et al. (2006). “Cancer risk among firefighters: A review and meta-analysis of 32 studies.” Journal Of Occupational And Environmental Medicine 48(11): 1189-1202.
20. Leong, S. T. and P. Laortanakul (2004). “Benzene and lead exposure assessment among occupational bus drivers in Bangkok traffic.” Journal Of Environmental Sciences—China 16(1): 61-66.
21. McConnell, R. (2008). “Asthma and Traffic-Related Exposure at Schools, Homes and on Roadways.” Epidemiology 19(6): 558-558.
22. Mustajbegovi, J., E. Zuskin, et al. (2001). “Respiratory function in active firefighters.” American Journal Of Industrial Medicine 40(1): 55-62.
23. NIOSH1005 http://www.cdc.gov/niosh/docs/2003-154/pdfs/1005.pdf.
24. NIOSH7903 http://cdc.gov/niosh/docs/2003-154/pdfs/7903.pdf.
25. NIOSH-NORA http://www.cdc.gov/niosh/NORA/about.html.
26. Obadia, M., G. M. Liss, et al. (2009). “Relationships Between Asthma and Work Exposures Among Non-Domestic Cleaners in Ontario.” American Journal Of Industrial Medicine 52(9): 716-723.
27. Parrish, M. E., J. L. Lyons-Hart, et al. (2001). “Puff-by-puff and intrapuff analysis of cigarette smoke using infrared spectroscopy.” Vibrational Spectroscopy 27(1): 29-42.
28. Ribeiro, M., U. D. Santos, et al. (2009). “Prevalence and Risk of Asthma Symptoms Among Firefighters in Sao Paulo, Brazil: A Population-Based Study.” American Journal Of Industrial Medicine 52(3): 261-269.
29. Sleiman, M., L. A. Gundel, et al. (2010). “Formation of carcinogens indoors by surface mediated reactions of nicotine with nitrous acid, leading to potential thirdhand smoke hazards.” PNAS asap.
30. Xu, F. and J. McGlotin (2003). “Video exposure assessments of solvent exposures in university pharmaceutical laboratories—a pilot study.” Chem. Heal. Saf. 10: 23-28.

1. A material comprising a molecularly imprinted polymer based on highly cross-linked styrene and/or divinylbenzene micro and nanoparticles for selective and sensitive detection of hydrocarbons.

2. A material comprising a blend based on an ionic liquid and a strong base for selective and sensitive detection of acids.

3. The material of claim 1 wherein the selective and sensitive detection of hydrocarbons comprises detecting an increase in the concentration of at least one component of the group consisting of: benzene, toluene, xylene, ethylbenzene, a monoaromatic hydrocarbon, a polycyclic aromatic hydrocarbon, a monoaromatic derivative, a polycyclic aromatic derivative, linear and branched alkyl hydrocarbons, a halogenated hydrocarbon, a petroleum derivative, and combinations thereof.

4. The material of claim 2 wherein the selective and sensitive detection of acids comprises detecting an increase in the concentration of at least one component of the group consisting of: hydrochloric acid, acetic acid, nitric acid, sulfuric acid, hydrofluoric acid, perchloric acid, hydrogen cyanide, hydrogen sulfide, fatty acids, branched-chain fatty acids, and combinations thereof.

5. The materials according to either of claims 1 or 2 wherein the sensing materials are coated onto hydrophobically modified sensors.

6. The material according to either of claims 1 or 2 wherein the sensing materials are coated onto sensors modified with materials selected from the group consisting of hydrophobic silanes, siloxanes, phenyl silane, hydrophobic thiols, dodecanethiol, hydrophobic polymers, and polystyrene.

7. The material of claim 1 wherein the sensing material is co-coated with materials selected from the group consisting of linear polymers, and polystyrene acting as binders of the micro/nanoparticles.

8. A sensor for detecting hydrocarbons, the sensor comprising a material including a molecularly imprinted polymer based on highly cross-linked styrene and/or divinylbenzene micro and nanoparticles for selective and sensitive detection of hydrocarbons; and at least one detector that measures the adsorption and/or absorption of hydrocarbons.

9. A sensor for detecting acids, the sensor comprising a material including a blend based on an ionic liquid and a strong base for selective and sensitive detection of acids; and at least one detector that measures the adsorption and/or absorption and/or reaction of acids.

10. (canceled)

11. An apparatus for sensing a change in environmental conditions, the apparatus comprising:
a sampling channel having an in-line particle filter;
a purging channel having a zeroing filter;
a pump;
a valve coupled to the sampling channel and the purging channel, the pump and a valve and pump control circuit;
a sensor or sensor array housed in a sensor cartridge, where one or several sensing elements are adapted to sense environmental materials and the sensor cartridge is coupled to receive air flow from the pump; and
a detection circuit couple to the sensor cartridge.

12. (canceled)

13. The apparatus of claim 11 wherein the sensor or sensor array comprise quartz crystal tuning forks.

14. The apparatus of claim 11 wherein the change in environmental condition comprises a change in the concentration of at least one component of the group consisting of: benzene, toluene, xylene, ethylbenzene, monoaromatic hydrocarbons, polycyclic aromatic hydrocarbons, monoaromatic derivatives, polycyclic aromatic derivatives, linear and branched alkyl hydrocarbons, halogenated hydrocarbons, petroleum derivatives, and combinations thereof. or of the group consisting of: hydrochloric acid, acetic acid, nitric acid, sulfuric acid, hydrofluoric acid, perchloric acid, hydrogen cyanide, hydrogen sulfide, fatty acids, branched-chain fatty acids, and combinations thereof.

15. The apparatus of claim 11 wherein the sensor array achieves simultaneous detection of hydrocarbons and acids at detection limits of part-per-billion (ppb) levels at least.

16. The apparatus of claim 11 wherein a dew line is coupled to the sensor cartridge, and located before the sensor cartridge.

17. The apparatus of claim 16 wherein the dew line comprises nation based tubing.

18. The apparatus of claim 11 wherein a filter for interferents is coupled to the sensor cartridge, and located before the sensor cartridge.

19. The apparatus of claim 11 wherein the detection circuit comprises of a local controller that can send or receive electrical signals or other communication information through a link to another system.

20. The apparatus of claim 19 wherein the system includes a communication port, which receives information and/or electrical signals from the electronic circuit.

21. The apparatus of claim 19 wherein the system is a workstation, desktop, notebook, personal digital assistant, cellular phone, a wristwatch and/or a computer.

22. The apparatus of claim 19 where the system includes a user interface for signal processing and a results display, and the user interface is adapted to receive signals from the detection circuit and process selected signals for transmitting to the results display.

23. The apparatus of claim 19 wherein detection circuit is integrated with a chip for implementing an open wireless technology standard for exchanging data over short and long distances.

24. The system of claim 19 further comprising a communication port to communicate wirelessly and seamlessly the sensed results to another workstation, desktop, notebook, personal digital assistant, cellular phone, wristwatch and/or computer.

25. The material of claim 2 wherein the ionic liquid is selected from the group consisting of 1-butyl-3-methylimidazolium hexafluorophosphate, 1-butyl-3-methylimidazolium tetrafluorphosphate, and any other hydrophobic ionic liquid.

26. The material of claim 2 wherein the strong base is selected from the group consisting of hydroxide and compounds thereof.

27. The material of claim 3 wherein the linear or branched alkyl hydrocarbons are selected from the group consisting of hexane, dodecane, isooctane, icosane, and compounds thereof.

28. The material of claim 3 wherein the halogenated hydrocarbon is selected from the group consisting of chloroform, trichloroethylene, perchloroethylene, vinyl chloride, and compounds thereof.

29. The apparatus of claim 14 wherein the linear or branched alkyl hydrocarbons are selected from the group consisting of hexane, dodecane, isooctane, and icosan, and compounds thereof.

30. The apparatus of claim 14 wherein the halogenated hydrocarbons are selected from the group consisting of chloroform, trichloroethylene, perchloroethylene, and vinyl chloride, and compounds thereof.

31. A sensor array comprising:
a plurality of sensors wherein each sensor includes a material having a molecularly imprinted polymer based on highly cross-linked styrene and/or divinylbenzene micro and nanoparticles for selective and sensitive detection of hydrocarbons;
at least one detector that measures the adsorption and/or absorption of hydrocarbons; and
where the sensor array and at least one detector are integrated into a single device to achieve simultaneous detection of hydrocarbons and acids at detection limits of part-per-million (ppm) levels or lower.

32. A sensor array comprising:
a plurality of sensors wherein each sensor includes a material having a blend based on an ionic liquid and a strong base for selective and sensitive detection of acids;
at least one detector that measures the adsorption and/or absorption of hydrocarbons; and
where the sensor array and at least one detector are integrated into a single device to achieve simultaneous detection of hydrocarbons and acids at detection limits of part-per-million (ppm) levels or lower.

33. The apparatus of claim 11 wherein the sensor or sensor array comprises at least one sensor material having a molecularly imprinted polymer based on highly cross-linked styrene and/or divinylbenzene micro and nanoparticles for selective and sensitive detection of hydrocarbons.

34. The apparatus of claim 11 wherein the sensor or sensor array comprises at least one sensor material having a blend based on an ionic liquid and a strong base for selective and sensitive detection of acids.
